(19) United States
(12) Patent Application Publication
(10) Pub. No.: US 2019/0304008 A1
(43) Pub. Date: Oct. 3, 2019

(54) COLOR PALETTE GUIDED SHOPPING

(71) Applicant: Huedeck, Inc., Newark, CA (US)

(72) Inventor: Jinkang Cen, Union City, CA (US)

(21) Appl. No.: 16/372,115

(22) Filed: Apr. 1, 2019

Related U.S. Application Data
(60) Provisional application No. 62/651,083, filed on Mar. 31, 2018.

(51) Int. Cl. G06Q 30/06; G06N 3/08; G06K 9/62; G06F 16/53

(52) U.S. Cl. CPC G06Q 30/0643; G06Q 30/0629; G06F 16/53; G06K 9/6256; G06N 3/088

(57) ABSTRACT

Systems and methods are disclosed for color palette guided shopping. The disclosed systems and methods guide shoppers to select products with colors that are in harmony without the direct assistance of a professional artist or designer. The systems and methods described herein achieve this by employing machine learning system to generate complete color palettes based on partial color palette user input. One embodiment uses two learning networks working in tandem to learn from a corpus of reference color palettes and generate novel color palettes based on limited color input.

### CROSS-REFERENCE TO RELATED APPLICATIONS

This application claims the benefit of U.S. Provisional Patent Application No. 62/651,083, filed Mar. 31, 2018, which is hereby incorporated by reference in its entirety.

### FIELD OF INVENTION

The present disclosure relates to color palette guided shopping and more particularly to systems and methods for using machine learning models to generate color palettes and select products associated with generated color palettes.

### BACKGROUND

The background provided here is for the purpose of generally presenting the context of the disclosure.

Color theory refers to the study of colors and their interaction with each other. The concept of a color wheel dates to at least the Renaissance, with contributions over time from figures such as Sir Isaac Newton and Goethe. The color wheel places colors sequentially and logically ordered in a circular shape. Basic color theory principles stem from this arrangement of colors around the color wheel. For example, colors opposite each other on the color wheel are said to be complementary. Complementary colors cancel each other out when combined, yielding a neutral or gray color. Analogous colors are adjacent to each other on the color wheel. More sophisticated color schemes may be derived from these basic principles, such as the triadic color scheme which includes colors equidistant from each other on the color wheel.

Color theory also includes the concept of color harmony. Color harmony refers to the pleasing aesthetic appearance of colors together. Color harmony is not simply described in mathematical relationships between colors, but includes the emotional and artistic selection of an artist or designer. Because of this, color harmony is difficult to codify in a simple, deterministic way. It is difficult to select colors that are harmonious with other colors because it is not as simple as selecting patterns of colors from a color wheel. Rather, expert artists and designers may select colors with no apparent mathematical relationship that nonetheless exhibit harmony and are aesthetically pleasing to the eye.

One example of a professional skilled in determining color harmony is an interior designer. An interior designer may use their artistic vision of color harmony to select aesthetically pleasing color choices for home furnishings. Hiring a professional artist such as an interior designer is a costly and time-consuming process. However, a homeowner may not have the artistic training or skill to select harmonious colors themselves, leading to a poor selection of home furnishings and other items.

### SUMMARY

Systems and methods are disclosed for color palette guided shopping. The disclosed systems and methods guide shoppers to select products with colors that are in harmony without the direct assistance of a professional artist or designer. The systems and methods described herein achieve this by employing a machine learning system to generate complete color palettes based on partial color palette user input. With the systems and methods disclosed herein, users may pick and shop for home furnishings and home décor items that exhibit color harmony with each other without a knowledge of color theory or any artistic training. The disclosed systems and methods also may assist professional interior designers and artists by increasing their efficiency in selecting products and determining colors that appear harmonious with each other. The embodiments described in this disclosure decrease the burden on users in selecting aesthetically pleasing products according to a color palette, or finding additional colors that are harmonious with the colors of items they already own. These systems and methods may assist users by lowering the cost of achieving professional-looking interior design results and increasing the ease at which professional-looking results are achieved.

As described below, a color palette guided shopping system according to one embodiment employs an advanced machine learning network to learn the patterns and skill of choosing harmonious colors. Then, the color palette guided shopping system develops novel color palettes based on limited user input. For example, the color palette guided shopping system may receive as input the colors that a user has in a room, and then suggest products that have colors that will appear harmonious with those colors. In this way, the color palette guided shopping system may replace the need to hire a professional interior designer to achieve professional results.

In an embodiment, a first computing device receives a selection of a first set of color values. The first computing device then transmits the first set of color values to a color palette guided shopping platform. The color palette guided shopping platform then generates a second set of color values based on the first set of color values, where the second set of color values includes the first set of color values and is harmonious with the first set of color values. Next, the color palette guided shopping platform searches a product database for products have colors that are harmonious with the first and second set of color values. Finally, the search results are transmitted to a user for browsing and purchasing. Other embodiments of this aspect include corresponding computer systems, apparatus, and computer programs recorded on one or more computer storage devices, each configured to perform the actions of the methods.

In some embodiments, an input image is provided to the first computing device and the first set of color values is derived from the input image. For example, the first set of color values may be derived from the input image by determining a number of groupings of pixels of the first image and determining an average or median value of all of the pixels of each grouping to produce a representative color for the grouping of pixels. In other embodiments, the first computing device presents a graphical user interface for color value selection and receives an input from a user indicating the first set of color values.

The color palette guided shopping platform may employ a trained neural network to generate the second set of color values based on the first set of color values. A second neural network may be used to train the first neural network. For example, a training database of synthetic user input and reference color palettes may be used in an unsupervised training routine that uses a second discriminator neural network configured to discriminate between generated color palettes and reference color palettes.

In some embodiments, users may input additional criteria to sort and filter products. For example, users may provide additional product criteria to the color palette guided shopping platform to further narrow search results. Implementations of the described techniques may include hardware, a method or process, or computer software on a computer-accessible medium.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates an exemplary network environment where some embodiments of the invention may operate;

FIG. 2 illustrates a color palette guided shopping system according to an embodiment;

FIG. 3 illustrates a method for selecting products according to an embodiment;

FIG. 4 illustrates an example graphical user interface for interacting with a guided shopping platform according to an embodiment;

FIG. 5 illustrates a color palette generator module 500 according to an embodiment;

FIG. 6 illustrates example input, output, and target color palettes of a color palette generator training process according to an embodiment;

FIG. 7 illustrates examples of color palettes that exhibit color harmony;

FIG. 8 illustrates a proportional color palette according to an embodiment; and

FIG. 9 illustrates a color palette extractor according to an embodiment.

In the drawings, reference numbers may be reused to identify similar and/or identical elements.

### DETAILED DESCRIPTION

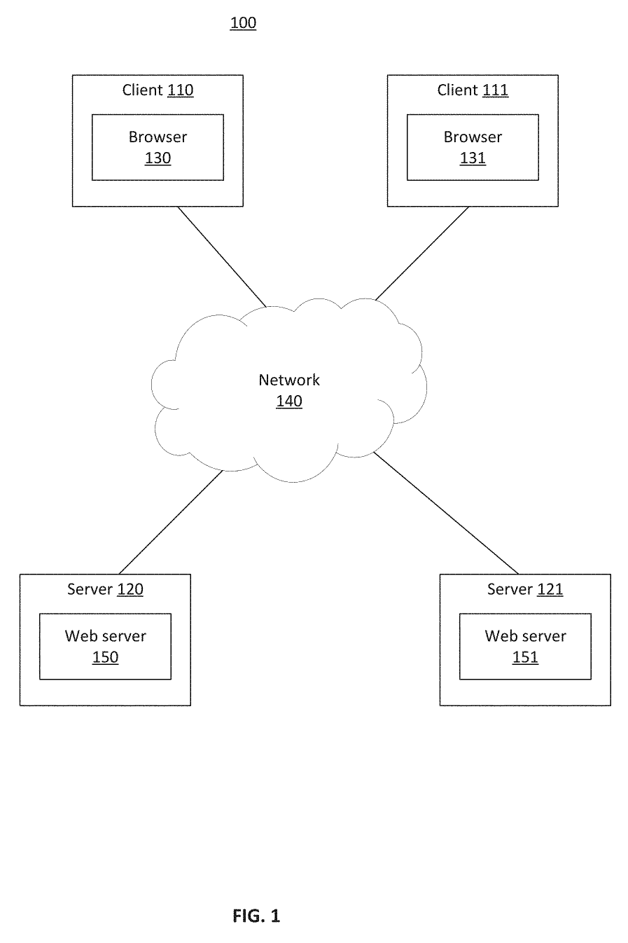

FIG. 1 illustrates an exemplary network environment 100 where some embodiments of the invention may operate. The network environment 100 may include multiple clients 110, 111 connected to one or more servers 120, 121 via a network 140. Network 140 may include a local area network (LAN), a wide area network (WAN), a telephone network, such as the Public Switched Telephone Network (PSTN), an intranet, the Internet, or a combination of networks. Two clients 110, 111 and two servers 120, 121 have been illustrated for simplicity, though in practice there may be more or fewer clients and servers. Clients and servers may be computer systems of any type. In some cases, clients may act as servers and servers may act as clients. Clients and servers may be implemented as a number of networked computer devices, though they are illustrated as a single entity. Clients may operate web browsers 130, 131, respectively for display web pages, websites, and other content on the World Wide Web (WWW). Servers may operate web servers 150, 151, respectively for serving content over the web.

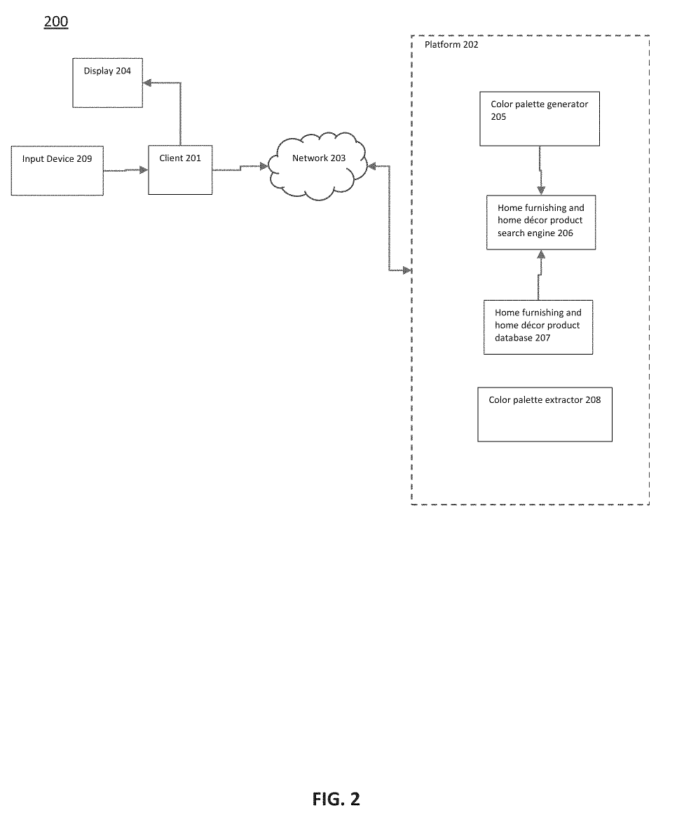

FIG. 2 illustrates a color palette guided shopping system 200 according to an embodiment. Color palette guided shopping system 200 may be used to facilitate shopping and selection of home furnishings, for example. In other embodiments, color palette guided shopping system 200 may be used to facilitate shopping and selection of other goods, such as but not limited to clothing, artistic materials, paint, cars, art, or any other such product category where color choice is important to the purchasing decision.

Client 201 is a client computing system configured to display graphical user interfaces via display 204 and receive user input via user input device 209. Client 201 may be, for example, a desktop computer with a computer monitor, keyboard, and mouse. Client 201 may be, in another embodiment, a tablet computer with a touchscreen interface. Client 201 may also be any other suitable client computing platform. Client 201 communicates with color palette guided shopping platform 202 via network 203. In an embodiment, client 201 may be a client such as client 110 illustrated in FIG. 1, network 203 may be a network such as network 140 illustrated in FIG. 1, and color palette guided shopping platform 202 may be a server such as server 120 illustrated in FIG. 1.

Color palette guided shopping platform 202 includes color palette generator 205. Color palette generator 205 receives as input a partial color palette from a user and returns a complete color palette based on the partial color palette. In an embodiment, the partial color palette may be designated by a user operating client 201. In another embodiment, the partial color palette may be derived by color palette extractor 208 from a photograph uploaded by client 201 to color palette guided shopping platform 202.

Color palette generator 205 then transmits the generated, complete color palette to search engine 206. Search engine 206 in turn search home furnishings and home décor product database 207 for products that are color harmonious with the generated color palette.

Certain components are illustrated as being located at color palette guided shopping platform 202. For example color palette generator 205, search engine 206, product database 207, and color palette extractor 208 are illustrated as being modules within color palette guided shopping platform 202. However, it is to be understood that any of these or any other module of subsystem of the disclosed color palette guided shopping system may be performed at any number of locations by any number of computing platforms, including client 201. For example, while color palette extractor 208 is illustrated as being a module within color palette guided shopping platform 202 in FIG. 2, in some embodiments it may be run on client 201, a server in proximity to color palette guided shopping platform 202, or a separate server in a different location than color palette guided shopping platform 202.

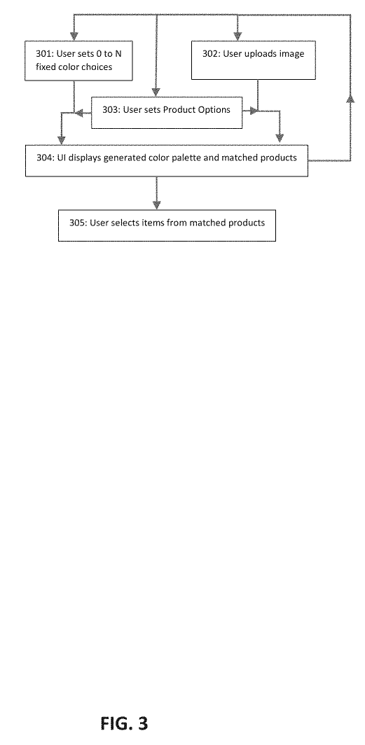

FIG. 3 illustrates a method for selecting products according to an embodiment using color palette guided shopping system 200. At step 301, a user may input their color choices. In an embodiment, the user may input anywhere between 0 and N color choices, where N is the number of colors in a color palette. For example, a standard color palette output may be a set of 5 color values. If the color input is less than the set number of color values of the output, the remaining values are determined by the color palette generator. For example, if the color input consists of 3 color values, the color palette generator determines 2 additional color values and returns the set of 5 color values that includes the 3 color values that were input and the additional 2 color values determined by the color palette generator. If the color input is the same size as the output color palette, this step may be bypassed. For example, if the color input consists of a complete 5-color palette, the color palette generator does not need to generate any additional color values. A user may also provide no color choices, i.e., a user may input 0 color values. In an embodiment, color palette guided shopping system 200 may provide a randomly selected color input if no other color input is provided.

At step 302, a user may optionally upload an image to designate color input. In an embodiment, the guided shopping platform receives the user's uploaded image and derives an input color palette, either a complete or partial color palette, from the user's uploaded image.

At step 303, the user may also input various product options that further narrow the products they wish to browse. For example, the user may input desired style, product type, size, material, price, brand, keyword, or other such product options. For example, in addition to a color input, a user may specify that they are shopping for couches made of microfiber and in a modern style to further narrow the products which are displayed. At this step, a user may also input color styles or preferences. For example, color styles may include the basic styles such as warm style, cool style, neutral style, colorful style, light style, dark style and other hybrid styles that combine two or more of those basic styles.

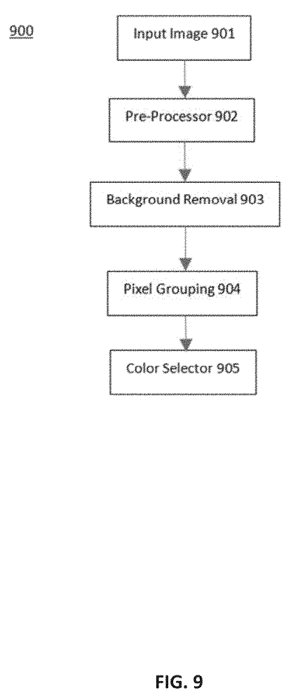

At step 304, the user's color input and product options are transmitted to the guided shopping platform. The guided shopping platform then generates a complete color palette by using a color palette generator module and searches a database of products based on the generated color palette and the other user input product options. The guided shopping platform then returns the list of matched products and associated information such as images of the matched products to the client. The client then displays the list of products in a graphical user interface for the user to browse matched products. The main colors of a product in the shopping system are determined by color palette extractor 208, which is also illustrated in FIG. 9. To find the product with matched color, the shopping system looks for products with colors within certain distance to any colors in the generated color palette. In an embodiment, color distance is calculated by

ΔE_{ab}=\sqrt{(L*₂−L*₁)²+(a*₂−a*₁)²+(b*₂−b*₁)²}

where (L*₁, a*₁, b*₁) and (L*₂, a*₂, b*₂) are the CIELAB color space coordinate values of the two pixels that are being compared. In another embodiment, color distance is calculated by

ΔE_{ab}=\sqrt{2×(R₂−R₁)²+4×(G₂−G₁)²+3×(B₂−B₁)²}

where (R₁, G₁, B₁) and (R₂, G₂, B₂) are the RGB values of the two pixels that are being compared. To find the products with other matched product options, the system searches the other attributes of the products which are stored in the product database. A user may then select the matched products they are interested in at step 305. The guided shopping platform may then facilitate a purchase of the products the user is interested in, or may redirect the user to a third part system for purchase of products.

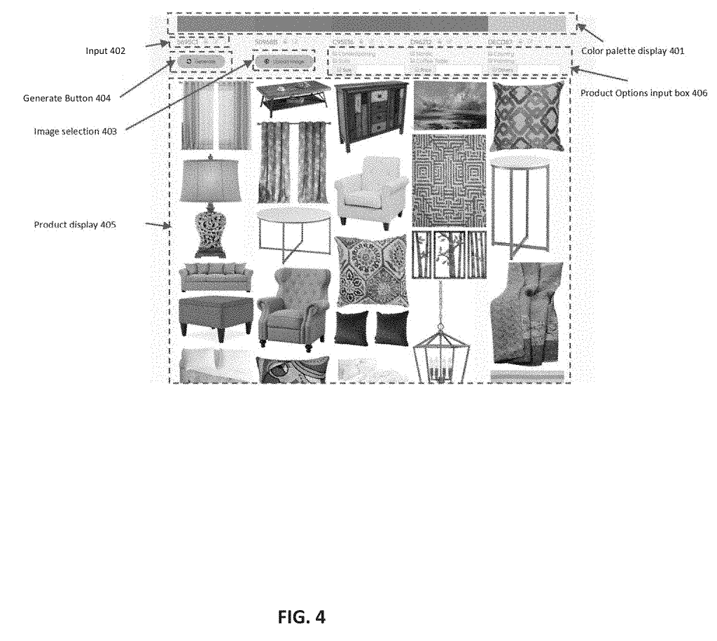

FIG. 4 illustrates an example graphical user interface 400 for interacting with a guided shopping platform according to an embodiment. At the top of the example graphical user interface, a 5-color palette 401 may be displayed. The 5-color palette 401 may be a generated color palette received from the guided shopping platform or may be an example color palette to display before the user has made their color choices. Input box 402 provides a manual input for color choices. For example, a user may input a color manually by typing in a hexadecimal value into input box 402 to designate a color input. In other embodiment, the input box 402 may bring up a color picker user interface where a user can click and pick a color from HSV color space. Image selection 403 provides a method for selecting an image from which to determine a color input. In an embodiment, the client system derives a color palette from the selected image and then transmits the determined color palette to the guided shopping platform. In an alternative embodiment, the client system uploads a selected image to the guided shopping platform, and the guided shopping platform derives a color palette from the image. In some embodiments, users may input additional criteria to sort and filter products. For example, users may provide additional product criteria at product options input box 406 to further narrow search results. Examples of product options that may be input to product options input box 406 include, for example, size, weight, price, style, material, brand, keyword filters, and other such product options. Generate button 404 transmits an instruction to the guided shopping platform to generate a color palette from the user input, whether it be from manual entry into input box 402 or image selection 403. Finally, product display area 405 presents products that are selected by the guided shopping platform. In an embodiment, the display area may comprise a grid of photos of the products selected by the guided shopping platform.

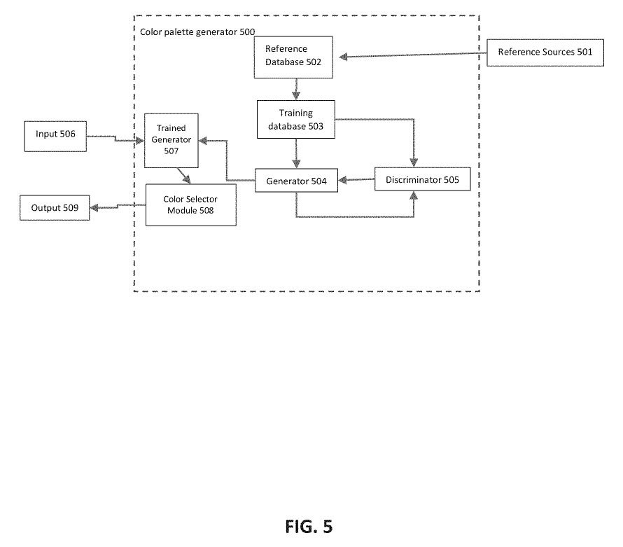

FIG. 5 illustrates a color palette generator module 500 according to an embodiment. Color palette generator module uses machine learning technology to learn the patterns of reference color palettes. Reference database 502 comprises a set of color palettes from expert reference sources 501. These reference color palettes comprise sets of associated colors that are determined to appear harmonious. For example, the reference color palettes may be sourced from expert designers, reference images, and other sources of reference color palettes.

Training database 503 comprises data used to train color palette generator module 500. The training data comprises training inputs and target outputs corresponding to the training inputs. Target outputs are reference color palettes received from reference color palette database 502. The training inputs are generated hypothetical user inputs derived from a reference color palette. To generate a training input, a subset of a reference color palette is selected and the remaining colors of the training palette are synthesized. For example, if a reference color palette comprises 5 colors, a training input derived from that reference color palette may comprise 3 out of the original 5 color inputs. The remaining 2 discarded colors may be replaced by a randomly generated color or a default color such as black or white. In this way, by varying the selected subset of the original reference color palette, multiple training color palettes may be derived from each reference color palette.

Training database 503 provides inputs to both discriminator 505 and generator 504. Generator 504 is a convolution-deconvolution network that receives a partial color palette input and generates a complete color palette output. In some embodiments, generator 504 may be implemented by any type of machine learning network, including but not limited to a convolutional neural network, a multilayer perceptron, or other such learning network. In an example, if a desired color palette output comprises N colors, a partial color palette input may be anywhere between 1 and N−1 colors. During training, partial color palette inputs are provided from training database 503. In operation, partial color palette inputs are received from user inputs.

Discriminator 505 evaluates the generated color palettes from generator 504 and judges whether or not the generated color palettes is similar to those in reference database 502. In this way, discriminator 505 seeks to classify color palettes as either belonging to the reference set or not. In an embodiment, discriminator 505 is implemented as a neural network similar to generator 504. For example, discriminator 505 may be a convolutional neural network. Discriminator 505 receives a generated color palette from generator 504, and a training input from training database 503 comprising a reference color palette (i.e., the target output) and a synthesized hypothetical input (i.e., the training input). Discriminator 505 then evaluates two pairings of palettes: the first pair is the training input and target output, and the second pair is the training input and the generated color palette from generator 504. Discriminator 505 outputs a probability of each pairing being the one that includes the reference color palette from training database 503. For example, if generator 504 produces an ideal output that is exactly identical to the reference palette that the input was derived from, then discriminator 505 would assign each pair of evaluated images a 50% probability of being the pair including the reference palette. In another example, if generator 504 produces a very poor output, consisting of a color palette that does not look like a palette from the reference database 502, then discriminator 505 would produce a very low probability that the generated output is from the reference database, and a very high probability that the other evaluated pair was from the reference database.

Both discriminator 505 and generator 504 use backpropagation to iteratively improve their results. That is, discriminator 505 uses backpropagation to improve its ability to discriminate whether a color palette is generated or from the reference database, and generator 504 improves its ability to generate a palette that will fool discriminator 505 into believing the generated output is a reference palette. In an embodiment, the weights of discriminator 505 are adjusted based on the stochastic gradient decent optimization of the classification error. The stochastic gradient decent optimization of the classification error from discriminator 505 is also sent as feedback to generator 504. In this way, as the discriminator gets better in identifying the quality of an output image, the generator will also get better in generating better output.

Generator 504 also receives feedback from a separate function that steers the combined generator-discriminator training towards the reference palette. That is, in addition to receiving feedback from the discriminator 505, generator 504 also optimizes a comparison of the generated output to the reference input. In an embodiment, this second optimized function is the least absolute deviation between the generated palette and the reference palette. In other embodiments, other functions may be used such as the least absolute square deviation between the generated palette and the reference palette.

In an embodiment, the combined training process of generator 504 and discriminator 505 may be expressed in the following loss function:

[symbol]

(G,D)=E_{x,y}[log D(x,y)]+Eₓ[log(1−D(x,G(x))]

In this loss function, G is generator 504, D is discriminator 505, x is the input palette (i.e., the hypothetical palette derived from the reference palette), and y is the target palette (i.e., the reference palette). This loss function is shared by both generator 504 and discriminator 505. Discriminator 505 is configured to maximize the loss function. Generator 504 is configured to minimize the same loss function as well as the additional loss function:

[symbol]

_{L1}(G)=E_{x,y}[∥y−G(x)∥₁]

This second loss function is the loss function of least absolute deviation between the generated palette (i.e., G(x)) and the reference palette (i.e., y). The balance between the two loss functions [symbol] (G, D) and [symbol] _{L1}(G) may be set by a weighting factor on [symbol] _{L1}(G). In summary, in this embodiment, generator 504 (i.e., G) is trained to meet:

$${G}^{*} = arg {min}_{G} {max}_{D} ℒ ( G , D ) + λ {ℒ}_{L 1} ( G )$$

In this combined function, λ is the weight assigned to [symbol] _{L1}(G) In this way, generator 504 may adjust the balance between trying to generate an output that will pass the test of discriminator 505 (i.e., [symbol] (G, D)) and trying to generate an output that is closest to the reference input (i.e., [symbol] _{L1}(G)).

The above training routine may be run for many iterations over all samples in training database 503 until a desired training is reached. If the training routine is run too few times, the output of generator 504 may not be of acceptable quality, but if the training routine is run too many times, the generator 504 may converge on solutions which are mere repetition of the reference database. Therefore, implementation of this embodiment involves the skilled judgement of the implementer to determine how many training epochs are appropriate for a given implementation.

Once the training phase is complete, generator 504 becomes a trained generator 507 and may be used to generate color palettes for arbitrary inputs, such as those from user input. After training, discriminator 505, training database 503, and reference database 502 are not needed for generator 504 to generate color palettes.

In an embodiment, generator 504 may be configured to generate color palettes of any number of colors based on any number of color inputs. For example, generator 504 may be configured to generate color palettes of 5 colors based on anywhere between 1 and 4 color value inputs. In another example, generator 504 may be configured to generate color palettes of 32 colors based on anywhere between 1 and 31 color value inputs. In some embodiments, the generated color palettes may be reduced in size for a given application by a color selector module 508. For example, in an embodiment, generator 504 may generate color palettes containing 32 colors, but then a subsequent step may select a subset of those colors for inclusion in a color palette of 5 colors. The selection of colors may be random, or colors may be selected according to a heuristic or other selection criteria such as color style. In an embodiment, a random subset of a 32 color palette is selected for inclusion in a 5 color palette. In this way, the same input may generate a variety of outputs all determined by generator 504 to be harmonious with each other. In another embodiment, color style may be classified in the following ways in the HSL color space where Hue (H) in range of 0 to 360, and Saturation (S) and Lightness (L) in range of 0 to 1.

For warm style 0≤H≤80, 330≤H≤360, and 0.3≤L≤0.7;

Cool style 80<H<330, and 0.3≤L≤0.7;

Neutral style 0.1≤S≤0.4, and 0.3≤L≤0.7;

Colorful style 0.4≤S≤1, and 0.3≤L≤0.7;

Light style 0.55≤L≤0.95;

Dark style 0.1≤L≤0.45.

To select a subset of colors in certain color style, the system selects the color that has the corresponding color values within the range according to the style. If the system cannot find enough colors with specific style from the generated color palettes to the subset, the rest of the colors will be sorted and the color with the closest value to the style will be selected.

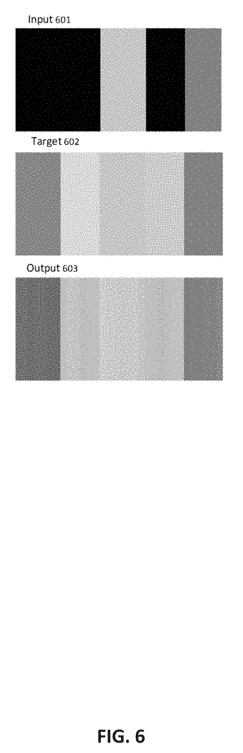

FIG. 6 illustrates example input, output, and target color palettes of a color palette generator training process according to an embodiment. Color palette 602 is an example reference color palette from an external source such as an expert designer or artist. Color palette 601 is an example hypothetical input derived from color palette 602 that selects 2 colors from color palette 602 and discards the other 3. Color palette 601 is an example representation of what a hypothetical user may provide as input, and color palette 602 is an expertly designed color palette that includes the colors from color palette 601. In this example, color palette 603 is the output of a color palette generator module when provided the input of color palette 601. As illustrated in color palette 603, the generated output is similar to the reference palette 602, demonstrating the ability of the color palette generator module to generate harmonious color palettes from limited color inputs.

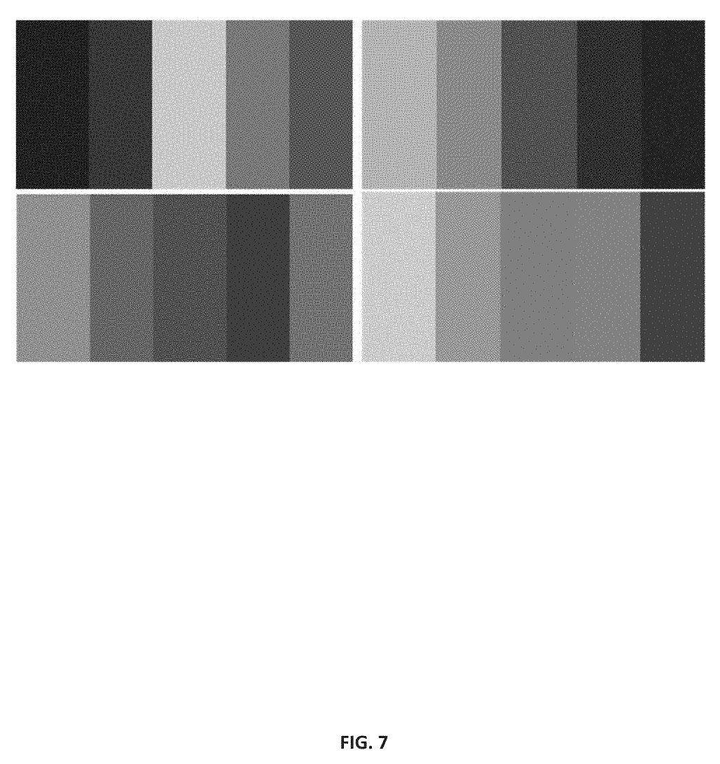

FIG. 7 illustrates 4 examples of color palettes that exhibit color harmony. These are examples of color palettes generated by a color palette generator module according to an embodiment.

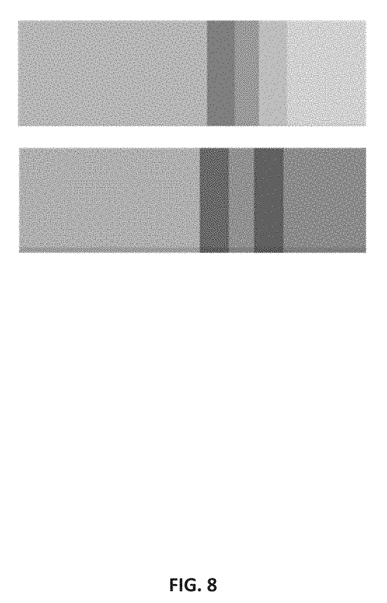

FIG. 8 illustrates a proportional color palette according to an embodiment. In an embodiment, proportional color palettes with dominate and accent colors may be used from reference sources 501. The proportion represents the abundance of the color in the sources. The proportions are illustrated by the size of the portion of the block occupied by the color. The larger proportional color becomes the dominate colors in the palette while the smaller proportional ones becomes the accent colors. Therefore, the reference database 502 contains those proportional color palettes and the color palette generator 500 is trained to generate proportional palettes. Once a proportional palette is generated according to a user input, the shopping system searches the larger furnishing and décor products to match the dominate colors while it searches the smaller products to match the accent colors. For example, the larger furnishing products include sofas, cabinets, tables, curtains, rugs, paints and etc., while the smaller products include accent chair, lamps, pillows, vases, decorative accents and etc. The color palette in FIG. 8 illustrates colors of a palette that are presented in differing proportions, rather than equal proportions.

FIG. 9 illustrates the details of a color palette extractor 208 which is used to extract a representative color palette from images a user upload or from images that the system uses as part of the reference sources 501. It is also used to determine the main colors of the products in the shopping database from a product image. The color palette extractor derives a partial color palette by determining a number of groupings of pixels of the first image and determining an average or median value of all of the pixels of each grouping to produce a representative color for the grouping of pixels. Pre-processor 902 conducts initial image processing on input image 901 from either a user or a product. In an embodiment, initial image processing may include formatting which formats images into a generic format if it is not, resizing which resizes images into smaller ones of square shape such as 256 by 256 pixels from larger sizes. Background removal 903 removes background colors that are not associated with the colors of the object to be extracted. In an embodiment, the background removal starts with global thresholding which remove pixels that have similar colors as a reference color value taken from the average or median value of all the pixels at the edge of the image. In an embodiment, color similarity is calculated by

ΔE_{ab}=\sqrt{(L*₂−L*₁)²+(a*₂−a*₁)²+(b*₂−b*₁)²}

where (L*₁, a*₁, b*₁) and (L*₂, a*₂, b*₂) are the CIELAB color space coordinate values of the two pixels that are being compared. In another embodiment, color similarity is calculated by

ΔE_{ab}=\sqrt{2×(R₂−R₁)²+4×(G₂−G₁)²+3×(B₂−B₁)²}

where (R₁, G₁, B₁) and (R₂, G₂, B₂) are the RGB values of the two pixels that are being compared. Addition steps in the background removal may be needed in order to further filter out unrelated colors. In an embodiment, a Sobel filter is used to detect the edge of the object in the image so that the shape of the object can be identified and the pixels outside of the detected shape will be removed. Pixel grouping 904 groups similar color pixels in the same group from the remaining pixels after background removal and sorts those groups in the descendent order of the number of pixels in the group. Color similarity is calculated in the same way as that in background removal in either CIELAB color space or RGB color space, however the value of ΔE_{ab} may be higher in this step in order to include more noticeable colors in the same group. The average or median color value of each group is calculated to represent the color of each group. Color selector 905 picks colors from the representative color of each group. For product image, color selector may pick only the first few representative colors from those groups to represent the most abundant colors of the product. As for images a user uploads, color selector may also pick the first few representative colors from those groups in an embodiment. In other embodiment, it may pick the colors according to the color style a user has configured, such as warm style, cool style, neutral style, colorful style, light style and dark style.

In an embodiment, the color palette guided shopping system may automatically select furniture for a given room. In this embodiment, a room size and layout is provided to the color palette guided shopping system. For example, a user may manually enter a room layout in a graphical user interface and upload it to the color palette guided shopping system. In another embodiment, a three-dimensional scan of a room is provided and the size and layout of the room is determined by the color palette guided shopping system. For example, a room scan may be performed by using a Light Detection and Ranging (LIDAR) device, using a structured light scanning technique, or derived from two-dimensional photos of a room. In these embodiments, the product database may include additional information about the products such as CAD models of the products or other detailed measurements of products. Then, the color palette guided shopping system may automatically select products based on the room size and dimensions and the product size and dimensions in addition to the other criteria described in this disclosure such as color harmony. In some embodiments, the color palette guided shopping system may then display the selected products in a virtual reality or augmented reality environment of the user's selected room.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A method for color palette guided shopping, the method comprising:
providing, to a first computing device, a first set of color values;
transmitting, by the first computing device and to a color palette guided shopping platform, the first set of color values;
generating, at the color palette guided shopping platform, a second set of color values based on the first set of color values, the second set of color values including the first set of color values;
providing a product database to the color palette guided shopping platform, the product database including a plurality of products and respective third sets of color values associated with each product;
searching the product database, by the color palette guided shopping platform, for products that are associated with a respective third set of color values that correspond to the second set of color values, yielding product search results; and
transmitting, from the color palette guided shopping platform and to the first computing device, the product search results.

2. The method of claim 1, wherein the providing a first set of color values comprises:
selecting, at the first computing device, a first image; and
determining the first set of color values from the first image.

3. The method of claim 2, wherein the determining the first set of color values from the first image comprises:
determining a number of groupings of pixels of the first image; and
for each of the number of groupings of pixels, determining an average or median value of all of the pixels of the grouping to produce a representative color for the grouping of pixels.

4. The method of claim 1, wherein the providing a first set of color values comprises:
presenting a graphical user interface on the first computing device; and
receiving an input, at the first computing device, that indicates the first set of color values.

5. The method of claim 1, wherein the generating a second set of color values based on the first set of color values comprises:
training a neural network to produce a trained neural network;
transmitting the first set of color values to the trained neural network; and
receiving, from the trained neural network, the second set of color values.

6. The method of claim 5, wherein training the neural network to produce the trained neural network comprises:
providing a reference database to the neural network, the reference database including reference color palettes acquired from expert sources;
generating synthetic user input from the reference database;
providing the reference database along with the synthetic user input to an unsupervised learning module; and
training the unsupervised learning module on the reference database and the synthetic user input to produce a trained neural network.

7. The method of claim 5, wherein training the neural network to produce the trained neural network comprises:
providing a second discriminator neural network, the second discriminator neural network configured to discriminate between generated color palettes and reference color palettes; and
training the neural network in part by receiving feedback from the second discriminator neural network.

8. The method of claim 1, further comprising:
providing, to a first computing device, a first set of product criteria; and
transmitting, by the first computing device and to a color palette guided shopping platform, the first set of product criteria, and
wherein the searching the product database further includes searching the product database for products that are associated with the first set of product criteria.

9. The method of claim 1, wherein the second set of color values are color harmonious with the first set of color values.

10. A system for color palette guided shopping, the system comprising:
a first computing device configured to receive a first set of color values;
a color palette guided shopping platform configured to receive, from the first computing device, the first set of color values;
a color palette generator configured to generate a second set of color values based on the first set of color values;
a product database including a plurality of products and associated third sets of color values of associated with each product;
a search engine configured to search the product database for products that are associated with a respective third set of color values that correspond to the second set of color values, producing search results; and
a user interface configured to receive the search results and display the search results.

11. The system of claim 10, further comprising a color palette extractor configured to derive a color palette from an image,
wherein the first computing device is further configured to receive an input image and transmit the input image to the color palette extractor, yielding a color palette derived from the input image, and
wherein the color palette derived from the input image is used as the first set of color values.

12. The system of claim 11, wherein the color palette extractor is configured to determine a number of groupings of pixels of the input image, and determine an average or median value of all of the pixels of each grouping to produce a representative color for the grouping of pixels.

13. The system of claim 10, wherein the first computing device includes a display and an input device, and
wherein the first computing device is configured to display a graphical user interface on the display and receive, via the input device, a selection of the first set of color values.

14. The system of claim 10, wherein the color palette generator includes:
a first neural network configured to generate a second set of color values based on the first set of color values.

15. The system of claim 14, further comprising:
a reference database including reference color palettes acquired from expert sources; and
a training database including reference color palettes from the reference database and associated synthetic input derived from reference color palettes.

16. The system of claim 14, further comprising:
a second discriminator neural network, the second discriminator neural network configured to discriminate between generated color palettes and reference color palettes; and
a training module configured to train the first neural network in part by receiving feedback from the second discriminator neural network.

17. The system of claim 10, wherein the first computing device is further configured to receive a first set of product criteria, and
wherein the search engine is further configured to search the product database for products that are associated with the first set of product criteria.

18. The system of claim 10, wherein the second set of color values are color harmonious with the first set of color values.

19. A method for color palette guided shopping, the method comprising:
receiving, by a color palette guided shopping platform, a first set of color values;
generating, by the color palette guided shopping platform, a second set of color values based on the first set of color values, the second set of color values including colors that are harmonious with the first set of color values;
determining that a product has colors that are harmonious with the first set of color values and the second set of color values; and
transmitting a product recommendation for the product to a client.

20. The method of claim 19, wherein the color palette guided shopping platform uses a convolutional network to generate the second set of color values based on the first set of color values.
